(19) United States
(12) Patent Application Publication
(10) Pub. No.: US 2024/0319321 A1
(43) Pub. Date: Sep. 26, 2024

(54) METHOD FOR IDENTIFYING A RADAR TRANSMITTER AND ASSOCIATED IDENTIFICATION SYSTEM

(71) Applicants: BULL SAS, Les Clayes-sous-Bois (FR); CENTRALESUPELEC, GIF-SUR-YVETTE (FR); Centre national de la recherche scientifique, PARIS (FR); UNIVERSITE PARIS-SACLAY, GIF-SUR-YVETTE (FR)

(72) Inventors: Manon MOTTIER, Paris (FR); Frédéric PASCAL, IVRY-SUR-SEINE (FR); Gilles CHARDON, PALAISEAU (FR)

(73) Assignees: BULL SAS, Les Clayes-sous-Bois (FR); CENTRALESUPELEC, GIF-SUR-YVETTE (FR); Centre national de la recherche scientifique, PARIS (FR); UNIVERSITE PARIS-SACLAY, GIF-SUR-YVETTE (FR)

(21) Appl. No.: 18/612,714

(22) Filed: Mar. 21, 2024

(30) Foreign Application Priority Data
Mar. 21, 2023 (EP) 23305384.2

(51) Int. Cl. G01S 7/02; G01S 7/40

(52) U.S. Cl. CPC G01S 7/021; G01S 7/4008

(57) ABSTRACT

The invention relates to a computer-implemented method for identifying a radar transmitter from a set of corresponding received pulses, each pulse being associated with a respective time of arrival. The method includes determining an observed signature of the radar transmitter based on a distribution of the time gaps between consecutive times of arrival. For each transmitter class among a plurality of predetermined transmitter classes, each transmitter class being associated with at least one expected signature, the method includes calculating a proximity score between the observed signature and each expected signature associated with said transmitter class. Each expected signature is a function of an expected distribution of the time gaps between consecutive times of transmission for said transmitter class, and for a predetermined pulse loss rate. The method also includes assigning the radar transmitter to the transmitter class associated with the expected signature that provides the best proximity score.

This application claims priority to European Patent Application Number 23305384.2, filed 21 Mar. 2023, the specification of which is hereby incorporated herein by reference.

### BACKGROUND OF THE INVENTION

### Field of the Invention

At least one embodiment of the invention relates to a method for identifying a radar transmitter from a set of corresponding received pulses, each received pulse being associated with a respective time of arrival.

At least one embodiment of the invention also relates to a computer program and to an identification system configured to implement such a method.

At least one embodiment of the invention applies to the field of signal processing, in particular to the identification of a radar transmitter from corresponding pulses.

### Description of the Related Art

A radar transmitter is described by the characteristics of the pulses that it transmits: frequency, pulse duration, level, time of arrival, direction of arrival, etc. However, technological evolution has led radar sources to have more complex and more similar electromagnetic spectra.

This makes it increasingly difficult to identify a radar transmitter (i.e., assign the radar transmitter to a respective transmitter class) from which pulses have been received, particularly in the presence of noise.

To overcome this problem, it has been proposed to use methods for analyzing the distribution of the time gaps between consecutive pulses received from a radar transmitter, insofar as each transmitter class is associated with a pulse repetition period law that is specific thereto.

However, such identification methods are not entirely satisfactory.

Indeed, not all of the pulses transmitted by the radar transmitter are necessarily detected at the receiver (for example, due to an insufficient signal-to-noise ratio), or are not assigned to said radar transmitter when a pulse deinterleaving step is carried out. This results in pulses missing from the detection signal.

Due to these missing pulses, the distribution of time gaps that is determined from the received pulses differs from the expected distribution, i.e., a distribution compliant with the pulse repetition period law associated with the class of the radar transmitter.

Consequently, the reliability of radar transmitter identification is compromised.

A purpose of at least one embodiment of the invention is to overcome at least one of the drawbacks of the prior art.

Another purpose of at least one embodiment of the invention is to provide a method for identifying a radar transmitter that is reliable, even in the event of pulse losses.

Another purpose of at least one embodiment of the invention is to provide a method for identifying a radar transmitter that is simple and that is not computing resources intensive.

### BRIEF SUMMARY OF THE INVENTION

To this end, at least one embodiment of the invention relates to a method of the aforementioned type, the method being implemented by computer and comprising the steps of:
determining an observed signature of the radar transmitter based on a distribution of time gaps between consecutive times of arrival;
for each transmitter class among a plurality of predetermined transmitter classes,
each transmitter class being associated with at least one expected signature,
calculating a proximity score between the observed signature and each expected signature associated with said transmitter class,
each expected signature being a function of an expected distribution of the time gaps between consecutive times of transmission for said transmitter class, and for a predetermined pulse loss rate; and
assigning the radar transmitter to the transmitter class associated with the expected signature that results in the best proximity score.

Indeed, by virtue of the provision, for each known transmitter class, of a plurality of expected signatures, each established according to the pulse repetition period law for said transmitter class, and for a predetermined pulse loss rate, the pulse loss effect described above is taken into account.

Comparing the distribution of the time gaps of the received pulses with each expected signature to obtain a proximity score leads to reliable identification of the radar transmitter in question.

Furthermore, the calculation of the proximity score is not computing resources intensive, such that the implementation of complex algorithms, such as artificial intelligence models, is avoided.

Advantageously, the method according to one or more embodiments of the invention includes one or more of the following features, taken either alone or according to any technically possible combination:
for each expected signature, the proximity score is a function of an optimal transport distance between the observed signature and said expected signature, the radar transmitter being assigned to the transmitter class associated with the expected signature for which the calculated optimal transport distance is smallest;
each received pulse is further associated with a corresponding frequency, and each transmitter class is associated with at least one transmission frequency, the observed signature further depending on the frequency of each received pulse, and, for each transmitter class, each expected signature further depending on each corresponding transmission frequency;
the observed signature is further dependent on a distribution of the frequencies of the received pulses, and, for each transmitter class, and for each loss rate, the corresponding expected signature depending on the associated expected distribution, repeated at each transmission frequency of the transmitter class;
each received pulse is further associated with a corresponding duration, and each transmitter class is associated with at least one transmitted pulse duration, the observed signature further depending on the duration of each received pulse, and, for each transmitter class, each expected signature further depending on each transmitted pulse duration;
the observed signature is further dependent on a distribution of the durations of the received pulses, and, for each transmitter class, and for each loss rate, the corresponding expected signature depending on the associated expected distribution, repeated at each pulse duration of the transmitter class;
the pulse loss rate is less than 0.5;
for each transmitter class, and for each predetermined pulse loss rate, the expected distribution of the time gaps is given by the law:

$${v}^{a} = \frac{1}{K} {\sum }_{n = 0}^{∞} ( 1 - a ) {a}^{n} {\sum }_{k = 1}^{K} {δ}_{{t}_{n k}}$$

where v^{α} is the expected distribution,
α is the pulse loss rate,
K is the number of repetition periods associated with the transmitter class,
δ is the Dirac measure, and
tₙₖ is equal to:

$${\sum }_{m = k}^{k + n} {π}_{m [ K ]}$$

where [ ] is the “modulo” operator, intended to characterize a congruence relation between integers,
m[K] is the remainder of the Euclidean division of m by K, and
π_{m[K]} is the repetition period of the transmitter class of which the rank has the value m[K];
for at least one transmitter class, the repetition period may take any value in at least one predetermined interval, the expected distribution of the time gaps, for each predetermined pulse loss rate, being given by the law:

$${v}^{a} ( t ) = \frac{1}{K} {\sum }_{n = 0}^{∞} ( 1 - a ) {a}^{n} {\sum }_{k = 1}^{K} {p}_{nk} ( t )$$

where v^{α} is the expected distribution,
α is the pulse loss rate,
K is a number of repetition periods associated with the transmitter class,
pₙₖ is a probability density function of a Gaussian variable Tₙₖ equal to:

$${\sum }_{m = k}^{k + n} {J}_{m}$$

Jₘ being a Gaussian variable representative of the m^{th} repetition period among the K repetition periods, having a predetermined expected value μₘ and predetermined variance σₘ², the variables Jₘ being independent.

According to at least one embodiment of the invention, a computer program is provided which comprises executable instructions, which, when they are executed by a computer, implement the steps of the method as defined above.

The computer program may be in any computer language, such as, for example, in machine language, in C, C++, JAVA, Python, etc.

According to one or more embodiments of the invention, an identification system is provided for identifying a radar transmitter from a set of corresponding received pulses, each received pulse being associated with a respective time of arrival, the identification system comprising a processing unit configured to:
determine an observed signature of the radar transmitter based on a distribution of time gaps between consecutive times of arrival;
for each transmitter class among a plurality of predetermined transmitter classes, each transmitter class being associated with at least one expected signature,
calculate a proximity score between the observed signature and each expected signature associated with said transmitter class, each expected signature being a function of an expected distribution of the time gaps between consecutive times of transmission for said transmitter class, and for a predetermined pulse loss rate; and
assign the radar transmitter to the transmitter class associated with the expected signature that results in the best proximity score.

The identification system according to at least one embodiment of the invention may be any type of apparatus such as a server, a computer, a tablet, a calculator, a processor, or a computer chip, programmed to implement the method according to one or more embodiments of the invention, for example by running the computer program according to at least one embodiment of the invention.

### BRIEF DESCRIPTION OF THE DRAWINGS

One or more embodiments of the invention will be better understood from reading the following description, which is given solely by way of non-limiting example and with reference to the accompanying drawings. These show:

FIG. 1 is a schematic representation of an identification system according to one or more embodiments of the invention;

FIG. 2 is a flowchart of an identification method according to one or more embodiments of the invention, implemented by the system of FIG. 1;

FIG. 3 is a graph showing expected pulses for a first transmitter class, as a function of their frequency and their time of transmission; according to one or more embodiments of the invention;

FIG. 4 is a graph showing expected pulses for a first transmitter class, as a function of their duration and their time of transmission, according to one or more embodiments of the invention;

FIG. 5 is a graph showing expected pulses for a second transmitter class, as a function of their frequency and their time of transmission; according to one or more embodiments of the invention;

FIG. 6 is a graph showing expected pulses for a second transmitter class, as a function of their duration and their time of transmission; according to one or more embodiments of the invention;

FIGS. 7A to 7F are graphs each showing an expected distribution of the time gaps between pulses received from a radar transmitter of the first class, for several pulse loss rate values; according to one or more embodiments of the invention;

FIGS. 8A to 8F are graphs each showing an expected distribution of the time gaps between pulses received from a radar transmitter of the second class, for several pulse loss rate values; according to one or more embodiments of the invention;

FIG. 9 is a graph showing an observed signature of a radar transmitter to be identified, according to one or more embodiments of the invention;

FIG. 10 is a graph showing an alternative of the observed signature of the radar transmitter to be identified of FIG. 9, according to one or more embodiments of the invention; and

FIG. 11 is a graph showing an alternative of an expected signature, according to one or more embodiments of the invention.

### DETAILED DESCRIPTION OF THE INVENTION

It is clearly understood that the one or more embodiments that will be described hereafter are by no means limiting. In particular, it is possible to imagine alternatives of the one or more embodiments of the invention that comprise only a selection of the features disclosed hereinafter in isolation from the other disclosed features, if this selection of features is sufficient to confer a technical benefit or to differentiate the one or more embodiments of the invention with respect to the prior art. This selection comprises at least one, preferably functional, feature which is free of structural details, or only has a portion of the structural details if this portion alone is sufficient to confer a technical benefit or to differentiate the one or more embodiments of the invention with respect to the prior art.

In particular, all of the described variants and embodiments may be combined with each other if there is no technical obstacle to this combination.

In the figures and in the remainder of the description, the same reference has been used for the features that are common to several figures.

A radar transmitter identification device 2 according to one or more embodiments of the invention is shown in FIG. 1.

The identification device 2 is intended to identify a radar transmitter from a set of corresponding detected radar pulses (hereinafter referred to as a “pulse group”).

By “identify a radar transmitter”, it is meant, in the context of the one or more embodiments of the invention, assigning said radar transmitter to a corresponding transmitter class among a plurality of known transmitter classes.

For each pulse group, the corresponding radar pulses (hereinafter simply referred to as “pulses”) have been previously received by a receiver and, for example, have undergone deinterleaving during which the pulses from the same radar transmitter were gathered into a same group. In other words, it has been previously determined that the pulses of the same pulse group ideally all come from the same radar transmitter.

The identification device 2 comprises a memory 4 and a processing unit 6 connected to one another.

The identification device 2 may be in hardware form, such as a computer, a server, a processor, an electronic chip, etc. Alternatively or additionally, the identification device 2 may be in software form, such as a computer program or an application, for example an application for a user apparatus like a tablet or smartphone.

### Memory

The memory 4 is configured to store, for each detected pulse, a respective time of arrival.

For example, for each detected pulse, the respective time of arrival was previously obtained by means of a preprocessing stage configured to detect and timestamp each pulse received by the receiver.

Preferably, the memory 4 is also configured to store, for each received pulse, respective frequency and duration.

For example, for each pulse, the corresponding frequency and duration were previously obtained by means of the preprocessing stage, which is also configured to determine said characteristics for each detected pulse.

The memory 4 is also configured to store, for each known transmitter class, at least one expected distribution of the time gaps (referred to as the “expected distribution”, and denoted by v^{α}), each expected distribution being associated with a respective pulse loss rate (or “loss rate”).

By “loss rate”, it is meant, in the context of the one or more embodiments of the invention, the fraction of the pulses transmitted by the radar transmitter which are not detected.

Furthermore, the memory 4 is also configured to store, for each known transmitter class, at least one corresponding expected signature.

### Processing Unit

The processing unit 6 is a hardware processing unit, such as a processor, an electronic chip, a calculator, a computer, a server, etc. Alternatively or additionally, the processing unit 6 is a software processing unit, such as an application, a computer program, a virtual machine, etc.

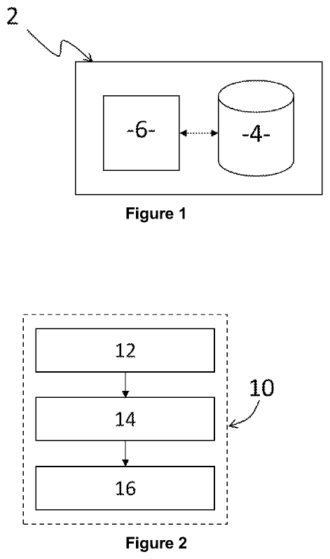

The processing unit 6 is configured to implement an identification method 10 (FIG. 2) in order to assign the radar transmitter to the corresponding transmitter class, based on the associated pulse group.

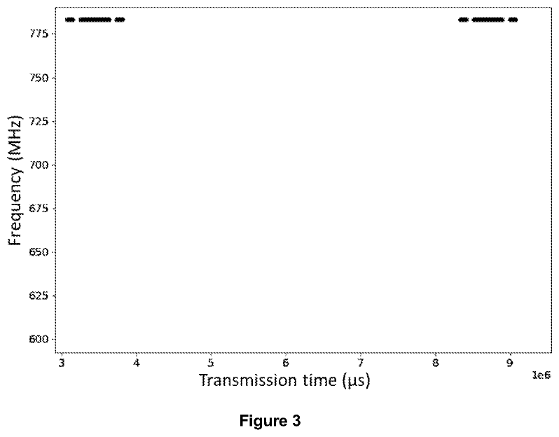

The implementation of the identification method 10 according to the invention will be described with reference to the example of FIGS. 3 to 9.

In this example, which is given for illustrative purposes, there are two distinct known transmitter classes, referred to as the “first class” and the “second class”, respectively.

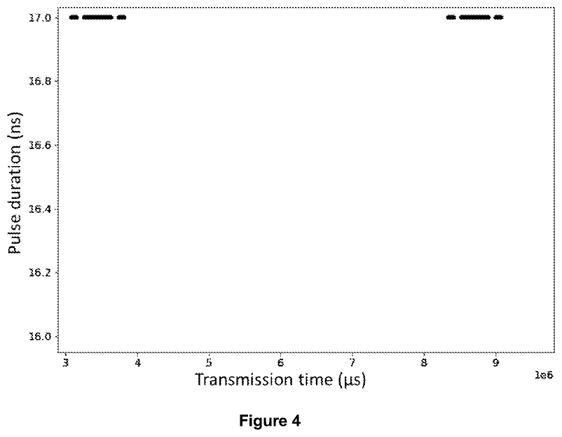

FIG. 3 shows an example of expected pulses for the first transmitter class, represented according to their frequency and to their time of transmission, according to one or more embodiments of the invention. In FIG. 4, these pulses are shown according to their duration and to their time of arrival, according to one or more embodiments of the invention.

As can be seen from FIGS. 3 and 4, a radar transmitter belonging to the first class is configured to transmit pulses that have a duration of 17 ns (nanoseconds), at a single frequency of 790 MHz (megahertz).

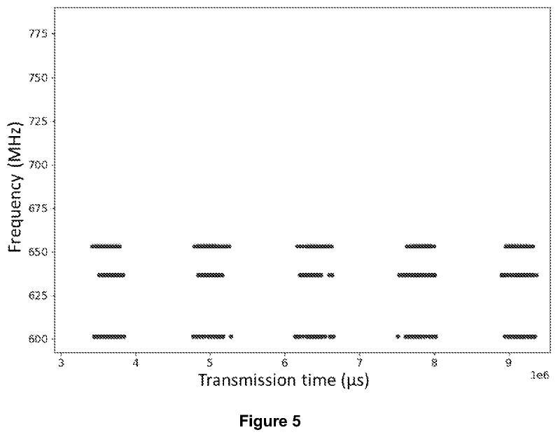

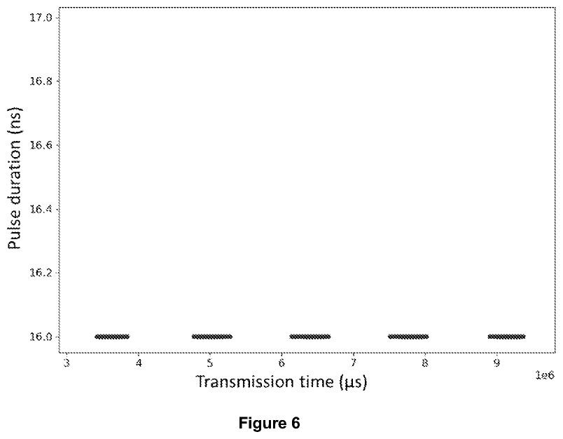

FIG. 5 shows an example of expected pulses for the second transmitter class, represented according to their frequency and to their time of transmission, according to one or more embodiments of the invention. In FIG. 6, these pulses are shown according to their duration and to their time of transmission, according to one or more embodiments of the invention.

As can be seen from FIGS. 5 and 6, a transmitter belonging to the second class is configured to transmit pulses that have a duration of 16 ns, at three distinct frequencies: 600 MHz, 635 MHz and 655 MHz.

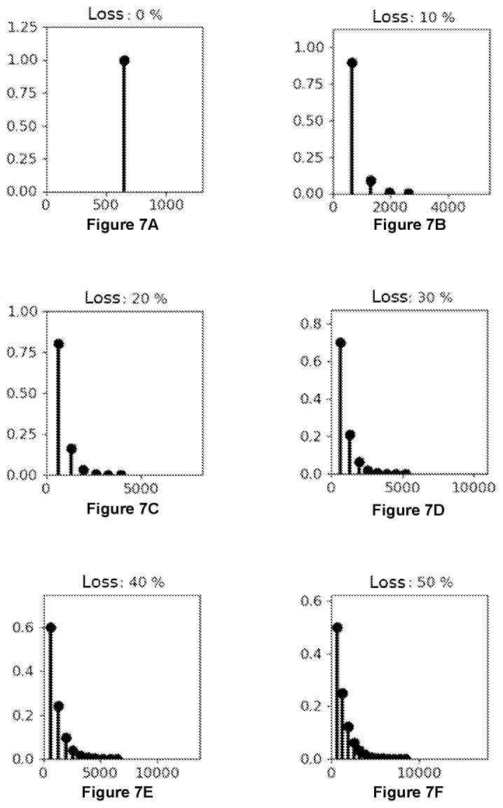

FIG. 7A shows the repetition period law for the first class, i.e., the law governing the repetition period for radar transmitters of the first class, according to one or more embodiments of the invention.

By “repetition period”, it is meant, in the context of at least one embodiment of the invention, a time gap between the times of transmission of two consecutive pulses.

Such a repetition period law is represented by means of a histogram showing the distribution of repetition periods for a radar transmitter of the first class, i.e., a histogram representative of the proportion according to which each repetition period is implemented for the transmission of radar pulses by said radar transmitter.

As can be seen from FIG. 7A, a radar transmitter belonging to the first class is configured to transmit pulses according to a single repetition period, namely 650 μs (microseconds), according to one or more embodiments of the invention.

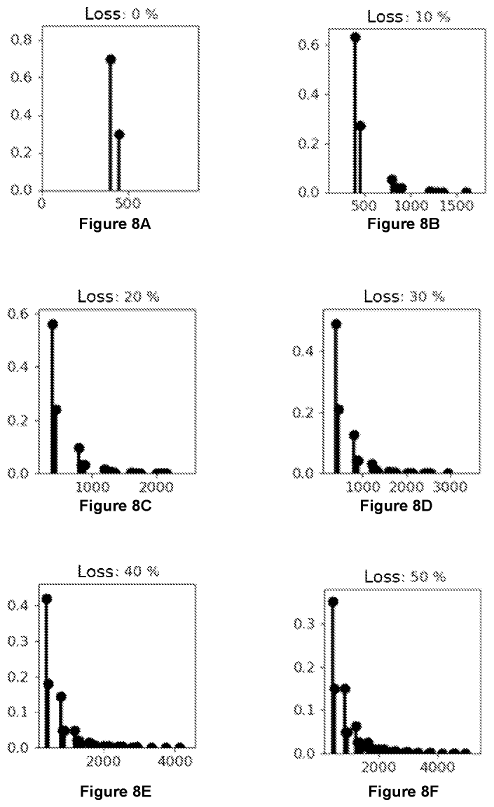

Furthermore, FIG. 8A shows the repetition period law associated with the second class, according to one or more embodiments of the invention.

As shown in FIG. 8A, according to one or more embodiments of the invention, a radar transmitter belonging to the second class is configured to transmit pulses according to two repetition periods: 400 μs and 450 μs.

It can also be seen from this FIG. 8A that, for a radar transmitter belonging to the second class, the corresponding repetition periods are implemented in the following proportions:
400 μs: 70%; and
450 μs: 30%.

In other words, in 70% of cases, two consecutive pulses are separated by a time interval of 400 μs and, in 30% of cases, two consecutive pulses are separated by a time interval of 450 μs.

Obviously, other distributions are conceivable. Furthermore, for a given transmitter class, one or more repetition periods may have the same proportion.

As mentioned above, each transmitter class is associated with at least one expected distribution v^{α} corresponding to a respective loss rate α.

More precisely, for each transmitter class, and for each loss rate α, the corresponding expected distribution v^{α} is governed by the law:

$${v}^{a} = \frac{1}{K} {\sum }_{n = 0}^{∞} ( 1 - a ) {a}^{n} {\sum }_{k = 1}^{K} {δ}_{{t}_{n k}}$$

where K is the number of repetition periods associated with the transmitter class,
δ is the Dirac measure, and
tₙₖ is equal to:

$${\sum }_{m = k}^{k + n} {π}_{m [ K ]}$$

where [ ] is the “modulo” operator, intended to characterize a congruence relation between integers,
m[K] is the remainder of the Euclidean division of m by K, and
π_{m[K]} is the repetition period of the transmitter class of which the rank has the value m[K].

In particular, FIGS. 7A and 8A correspond to an expected distribution v^{α} for a loss rate α of zero, i.e., when all of the pulses transmitted by the radar transmitter are detected, according to one or more embodiments of the invention.

Furthermore, by way of at least one embodiment, a plurality of expected distributions v^{α} are shown in FIGS. 7B to 7F for the first class, and in FIGS. 8B to 8F for the second class. FIGS. 7B to 7F, in at least one embodiment, correspond to loss rates of 10%, 20%, 30%, 40% and 50%, respectively; the same applies for FIGS. 8B to 8F according to one or more embodiments of the invention.

It is advantageous to associate, with each transmitter class, a plurality of expected distributions v^{α}, each corresponding to a respective loss rate α. Indeed, such a feature makes it possible to take into account situations where not all of the pulses transmitted by a corresponding radar transmitter are detected. This results in an observed gap between two consecutive pulses which differs from the theoretical repetition periods for said transmitter class. In this case, the observed distribution of the time gaps between the consecutive times of arrival of the pulses transmitted by a radar transmitter of said transmitter class comprises, in addition to the peaks with an abscissa equal to one of the theoretical repetition periods for said transmitter class, peaks that each have an abscissa equal to an integer multiple of one of the theoretical repetition periods.

Advantageously, for each expected distribution v^{α}, the loss rate α is less than or equal to 0.5. Such a value corresponds to a situation in which every second pulse transmitted by the radar transmitter is not detected.

Such a threshold is advantageous insofar as a loss rate greater than 50% does not allow meaningful information to be extracted for the purpose of identifying the radar transmitter. Furthermore, the expected distributions v^{α} for a loss rate α greater than 0.5 tend to be very similar. Obviously, such a threshold is not limiting.

Preferably, for each transmitter class, each expected signature is an expected distribution v^{α} corresponding to a respective loss rate α.

As mentioned above, the processing unit 6 is configured to implement the identification method 10 in order to assign the radar transmitter to the corresponding transmitter class, based on the pulse group associated with said radar transmitter.

To perform the identification method 10, the processing unit 6 is configured to implement the steps of:
determining 12 an observed signature of the radar transmitter;
calculating 14 a proximity score; and
assigning 16 the transmitter to a transmitter class.

### Determining the Observed Signature of the Radar Transmitter

The processing unit 6 is configured to determine, during the determining step 12, an observed signature of the radar transmitter to be identified, based on the pulse group associated with the radar transmitter.

More precisely, for each pulse of the pulse group from the radar transmitter to be identified, the processing unit 6 is configured to associate a first value equal to the time gap between the time of arrival of said pulse and the time of arrival of the next pulse.

Furthermore, the processing unit 6 is configured to determine the observed signature as being a distribution of the first values.

In other words, the observed signature is the distribution of the time gaps between consecutive pulses associated with the radar transmitter to be identified.

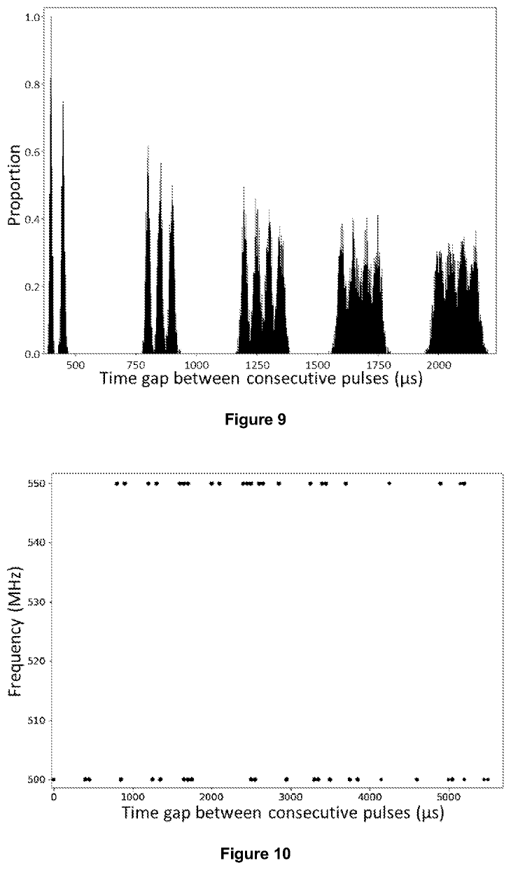

An example of a distribution observed for a radar transmitter to be identified is shown in FIG. 9 (the figure has been normalized).

### Calculating a Proximity Score

The processing unit 6 is also configured to calculate, during the calculating step 14, a proximity score between the observed signature and each expected signature stored in the memory 4, each expected signature being associated with a respective predetermined pulse loss rate α.

More precisely, the processing unit 6 is configured to calculate a proximity score between the observed signature and each expected signature for each transmitter class, in relation to a predetermined metric.

As a result, at the end of the calculating step 14, the number of calculated proximity scores is equal to the number of expected signatures stored in the memory 4.

Advantageously, for each expected signature, the corresponding proximity score depends on an optimal transport distance between the observed signature and said expected signature.

By “optimal transport distance”, it is meant, in the context of at least one embodiment of the invention, a value representative of the cost to transform one distribution into another, that is to say to move the points from one distribution to another.

For example, the proximity score is equal to the optimal transport distance between the observed signature and the expected signature.

The use of the optimal transport distance is advantageous because due to its calculation speed, insofar as it allows straightforward comparison between distributions, in particular those which have disjoint supports, which make classical distances unusable.

In the illustrative example of FIGS. 3 to 9, it can be seen that the distributions of FIGS. 8C and 9 are very similar, according to one or more embodiments of the invention. In particular, the observed distribution for the transmitter to be identified and the expected distribution of FIG. 8C exhibit peaks at the same time gaps between pulses, which indicates that the radar transmitter to be identified likely belongs to the second transmitter class. The optimal transport distance between the observed signature and the expected signature corresponding to the second class is therefore low. Conversely, according to one or more embodiments of the invention, it can be seen that the distribution of FIG. 9 has very little in common with the distributions of FIG. 7A to 7F, and the cost of transforming the observed distribution into any of the expected distributions 7A to 7F is higher than in the preceding case.

### Assigning the Transmitter to a Transmitter Class

The processing unit 6 is also configured to assign, during the assigning step 16, the radar transmitter to a transmitter class, based on the calculated proximity score.

More precisely, the processing unit 6 is configured to assign the radar transmitter to the transmitter class which is associated with the expected signature that results in the best proximity score.

In particular, in the case where the calculated score depends on the optimal transport distance, the processing unit 6 is configured to assign the radar transmitter to the transmitter class which is associated with the expected signature for which the calculated optimal transport distance is smallest.

In the preceding example, the processing unit 6 assigns the radar transmitter to be identified to the second class.

Advantageously, the processing unit 6 is configured to assign the radar transmitter to the transmitter class which is associated with the expected signature that results in the best proximity score, provided that the value of said best proximity score belongs to a predetermined interval.

In particular, in the case where the calculated score is a function of the optimal transport distance, the processing unit 6 is configured to assign the radar transmitter to the transmitter class which is associated with the expected signature for which the calculated optimal transport distance is smallest, provided that the calculated optimal transport distance is less than a predetermined maximum distance.

This is advantageous insofar as such a feature prevents a radar transmitter belonging to a transmitter class which is not listed in the memory 4 from being assigned, erroneously, to a known transmitter class.

Furthermore, the processing unit 6 is preferably configured to transmit an alert indicating the observation of a radar transmitter belonging to an unlisted transmitter class in the case where the value of the best proximity score is outside the predetermined interval.

Dependence of the Expected Signature on Frequency and/or on Pulse Duration

Optionally, the processing unit 6 is also configured to associate, in the determining step 12, a second value with each pulse of the pulse group from the radar transmitter to be identified, in addition to the first value.

In particular, for each pulse of the pulse group, the second value is equal to the corresponding frequency.

In this case, the processing unit 6 is configured to determine the observed signature as being a two-dimensional distribution, both of the first values and of the second values. An example of such an observed signature, according to one or more embodiments of the invention, is shown in FIG. 10: in this example, the radar transmitter is configured to transmit pulses that have a frequency equal to 500 MHz or 550 MHz, with a repetition period equal to 400 μs or 450 μs (according to proportions equal to 70% and 30%, respectively). Additionally, in this example, the loss rate is estimated at 20%.

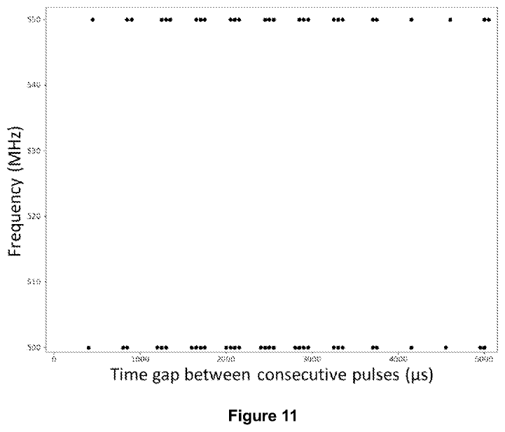

Furthermore, in this case, for each transmitter class, and for each loss rate α, the corresponding expected signature is a two-dimensional signature, in which the expected distribution v^{α} is repeated at each transmission frequency of the transmitter class. An example of such an expected signature, in at least one embodiment, is shown in FIG. 11: in this example, the radar transmitters of the considered transmitter class are configured to transmit pulses that have a frequency equal to 500 MHz or 550 MHz, with a repetition period equal to 400 μs or 450 μs (according to proportions equal to 70% and 30%, respectively). Additionally, in this example, the loss rate α is taken to be equal to 20%.

According to one or more embodiments, the processing unit 6 is also configured to associate, during the determining step 12, a third value with each pulse of the pulse group from the radar transmitter to be identified, in addition to the first value and the second value.

In particular, for each pulse of the pulse group, the third value is equal to the corresponding duration.

In this case, the processing unit 6 is configured to determine the observed signature as being a three-dimensional distribution of the first values, the second values and the third values simultaneously.

Furthermore, in this case, for each transmitter class, and for each loss rate α, the corresponding expected signature is a three-dimensional signature, in which the expected distribution v^{α} is repeated at each transmission frequency and at each pulse duration of the transmitter class.

More generally, for each transmitter class, and for each loss rate α, the corresponding expected signature is a signature that may have more than three dimensions. In this case, one of said dimensions is associated with the first value described above, namely the time gap between the times of arrival of two consecutive pulses.

Alternatively, the roles of frequency and pulse duration are reversed.

### Case of a Random Repetition Period Law

For certain transmitter classes, the corresponding repetition period law is random. This means that the time gap between two consecutive pulses may take any value in at least one predetermined interval I.

In this case, for each loss rate α, the corresponding expected distribution v^{α}, stored in the memory 4, is given by the law:

$${v}^{a} ( t ) = \frac{1}{K} {\sum }_{n = 0}^{∞} ( 1 - a ) {a}^{n} {\sum }_{k = 1}^{K} {p}_{nk} ( t )$$

where K is a number of repetition periods associated with the considered transmitter class (generally selected by the user in the case of a random repetition period law),
pₙₖ is a probability density function of a Gaussian variable Tₙₖ equal to:

$${\sum }_{m = k}^{k + n} {J}_{m}$$

Jₘ being a Gaussian variable representative of the m^{th} repetition period among the K repetition periods, of expected value μₘ and variance σₘ², μₘ and σₘ² each being a value selected by the user, the variables Jₘ being independent.

Preferably, each repetition period among the K repetition periods is associated with a corresponding interval I. In this case, each value μₘ is selected in the interval I associated with the repetition period m. Furthermore, each value σₘ² is dependent on the length of the interval I associated with the repetition period m.

Alternatively, variables governed by a distribution other than a Gaussian distribution may conceivably be implemented.

### Operation

The operation of the identification device 2 will now be described with reference to FIG. 2, according to one or more embodiments of the invention.

During an initializing step (not shown), the time of arrival corresponding to each pulse of the pulse group associated with the radar transmitter to be identified is written in the memory 4.

Preferably, for each received pulse, a respective frequency and a respective duration are also written in the memory 4.

Furthermore, for each known transmitter class, a plurality of expected signatures, each associated with a respective loss rate, are written in the memory 4.

Then, during the determining step 12, the processing unit 6 calculates the observed distribution based on the times of arrival of the pulses of the pulse group corresponding to the radar transmitter to be identified.

Then, the processing unit 6 determines the observed signature of the radar transmitter to be identified from the calculated observed distribution.

Then, during the calculating step 14, the processing unit 6 calculates the proximity score between the observed signature and each expected signature stored in the memory 4. In particular, the processing unit 6 calculates the optimal transport distance between the observed signature and each expected signature stored in the memory 4.

Then, during the assigning step 16, the processing unit 6 assigns the radar transmitter to be identified to the transmitter class which is associated with the expected signature that results in the best proximity score.

Of course, at least one embodiment of the invention is not limited to the examples disclosed above.

1. A computer-implemented method for identifying a radar transmitter from a set of corresponding received pulses, each received pulse of said set of corresponding received pulses being associated with a respective time of arrival, the computer-implemented method comprising:
determining an observed signature of the radar transmitter based on a distribution of time gaps between consecutive times of arrival;
for each transmitter class among a plurality of predetermined transmitter classes, each transmitter class of said plurality of predetermined transmitter classes being associated with at least one expected signature,
calculating a proximity score between the observed signature and each expected signature of said at least one expected signature associated with said each transmitter class,
said each expected signature being a function of an expected distribution of time gaps between consecutive times of transmission for said each transmitter class, and for a predetermined pulse loss rate; and
assigning the radar transmitter to the each transmitter class associated with the expected signature that results in a best proximity score.

2. The computer-implemented method according to claim 1, wherein, for said each expected signature, the proximity score is a function of an optimal transport distance between the observed signature and said each expected signature, the radar transmitter being assigned to the each transmitter class associated with the expected signature for which the optimal transport distance that is calculated is smallest.

3. The computer-implemented method according to claim 1, wherein said each received pulse is further associated with a corresponding frequency, and said each transmitter class is associated with at least one transmission frequency, the observed signature further depending on the corresponding frequency of said each received pulse, and for said each transmitter class, said each expected signature further depending on each corresponding transmission frequency of said at least one transmission frequency.

4. The computer-implemented method according to claim 3, wherein the observed signature is further dependent on a distribution of all of the corresponding frequency of the set of corresponding received pulses, and for said each transmitter class, and for each loss rate of said predetermined pulse loss rate of said each expected signature, the each expected signature corresponding thereto depending on the expected distribution associated therewith, repeated at each transmission frequency of the at least one transmission frequency of the each transmitter class.

5. The computer-implemented method according to claim 4, wherein said each received pulse is further associated with a corresponding duration, and said each transmitter class is associated with at least one transmitted pulse duration, the observed signature further depending on the at least one transmitted pulse duration of said each received pulse, and for said each transmitter class, said each expected signature further depending on said at least one transmitted pulse duration associated therewith.

6. The computer-implemented method according to claim 5, wherein the observed signature is further dependent on a distribution of the corresponding duration of the received pulses, and for said each transmitter class, and for said each loss rate, the expected signature corresponding therewith depending on the expected distribution associated therewith, repeated at said each pulse duration of the each transmitter class.

7. The computer-implemented method according to claim 1, wherein the predetermined pulse loss rate is less than 0.5.

8. The computer-implemented method according to claim 1, wherein, for said each transmitter class, and for said predetermined pulse loss rate of said each expected signature, the expected distribution of the time gaps is given by:
$${v}^{α} = \frac{1}{K} {\sum }_{n = 0}^{∞} ( 1 - α ) {α}^{n} {\sum }_{k = 1}^{K} {δ}_{{t}_{nk}}$$
where ν^{α} is the expected distribution,
α is the predetermined pulse loss rate,
K is a number of repetition periods associated with the each transmitter class,
δ is a Dirac measure, and
tₙₖ is equal to:
$${\sum }_{m = k}^{k + n} {π}_{m [ K ]}$$
where [ ] is a “modulo” operator, intended to characterize a congruence relation between integers,
m[K] is a remainder of a Euclidean division of m by K, and
π_{m[K]} is the is a repetition period of the each transmitter class of which a rank has the m[K] value.

9. The computer-implemented method according to claim 8, wherein, for at least one transmitter class of the plurality of predetermined transmitter classes, the repetition period may take any value in at least one predetermined interval, the expected distribution of the time gaps, for each predetermined pulse loss rate of said predetermined pulse loss rate of said each expected signature, being given by:
$${v}^{α} ( t ) = \frac{1}{K} {\sum }_{n = 0}^{∞} ( 1 - α ) {α}^{n} {\sum }_{k = 1}^{K} {p}_{nk} ( t )$$
where ν^{α} is the expected distribution,
α is the predetermined pulse loss rate,
K is a number of repetition periods associated with the each transmitter class,
pₙₖ is a probability density function of a Gaussian variable Tₙₖ equal to:
$${\sum }_{m = k}^{k + n} {J}_{m}$$
Jₘ being a Gaussian variable representative of an m^{th} repetition period among the K repetition periods, having a predetermined expected value μₘ and predetermined variance σₘ², Jₘ being an independent variable.

10. A non-transitory computer program comprising executable instructions which, when they are executed by a computer, implement a method for identifying a radar transmitter from a set of corresponding received pulses, each received pulse of said set of corresponding received pulses being associated with a respective time of arrival, the computer-implemented method comprising:
determining an observed signature of the radar transmitter based on a distribution of time gaps between consecutive times of arrival;
for each transmitter class among a plurality of predetermined transmitter classes, each transmitter class of said plurality of predetermined transmitter classes being associated with at least one expected signature,
calculating a proximity score between the observed signature and each expected signature of said at least one expected signature associated with said each transmitter class,
said each expected signature being a function of an expected distribution of time gaps between consecutive times of transmission for said each transmitter class, and for a predetermined pulse loss rate; and
assigning the radar transmitter to the each transmitter class associated with the expected signature that results in a best proximity score.

11. An identification system that identifies a radar transmitter from a set of corresponding received pulses, each received pulse of said set of corresponding received pulses being associated with a respective time of arrival, the identification system comprising:
a processor configured to
determine an observed signature of the radar transmitter based on a distribution of time gaps between consecutive times of arrival;
for each transmitter class from among a plurality of predetermined transmitter classes, said each transmitter class being associated with at least one expected signature,
calculate a proximity score between the observed signature and each expected signature of said at least one expected signature associated with said each transmitter class,
said each expected signature being a function of an expected distribution of time gaps between consecutive times of transmission for said each transmitter class, and for a predetermined pulse loss rate; and
assign the radar transmitter to the each transmitter class associated with the each expected signature that results in a best proximity score.
